(19) United States
(12) Patent Application Publication
(10) Pub. No.: US 2015/0061814 A1
(43) Pub. Date: Mar. 5, 2015

(54) FERRITE CIRCUIT BOARD

(71) Applicant: IBIS INNOTECH INC., Taichung City (TW)

(72) Inventors: Wei-Jen LAI, Jhubei City (TW); Chih-Kung HUANG, Hsinchu City (TW)

(21) Appl. No.: 14/475,950

(22) Filed: Sep. 3, 2014

(30) Foreign Application Priority Data
Sep. 5, 2013 (TW) 102216723

(51) Int. Cl. H01F 27/28

(52) U.S. Cl. CPC H01F 27/2804
USPC 336/200

(57) ABSTRACT

A ferrite circuit board includes a substrate and a wire. The substrate is made of ferrite and provided with a surface and an elongated groove recessed from the surface. The elongated groove has an inner wall having a roughness Ra ranging from 0.1 μm to 20 μm. The wire is embedded in the elongated groove of the substrate, such that the wire is not easily separated from the substrate. The ferrite circuit board can be used as an inductor to provide abundant functionality.

### CROSS-REFERENCE TO RELATED APPLICATION

This application claims priority from Taiwan Patent Application No. 10221672.3 field on Sep. 5, 2013, the entire content of which is incorporated herein by reference.

### BACKGROUND OF THE INVENTION

1. Field of the Invention

The present invention relates generally to circuit boards and more particularly, to a ferrite circuit board with firm structure and can be used as an inductor.

2. Description of the Related Art

A conventional circuit board primarily comprises an insulated substrate and a plurality of wires attached on a surface of the substrate. In the manufacturing process of the circuit board, a conductive material such as nickel-chromium alloy is first coated on the surface of the substrate by sputtering to serve as a seed layer thereon. Subsequently, a photolithography process is performed and a metal material such as copper is electroplated on the seed layer to form the wires. Thereafter, part of the seed layer that is not covered by the wires is removed by etching.

However, because the wires of the conventional circuit board protrude from the surface of the substrate, the wires may be easily separated from the substrate in the subsequent manufacturing process of the circuit board. Besides, when the part of the seed layer is etched, the seed layer located between the wires and the substrate is liable to be separated from the substrate due to over-etching. In addition, with the tendency of miniaturized-sized electronic elements, the wire of the circuit board is required to be made thinner, thereby reducing the contact area between the wires and the substrate, which in turn resulting in decrease of the structural stability between the wires and the substrate. Further, because the width and the thickness of the wire are respectively limited by usage requirement and sputtering process, the cross-sectional area of the wire is limited, such that it can only allow a limited amount of current to flow therethrough.

### SUMMARY OF THE INVENTION

In view of the above-mentioned drawbacks of the prior art, it is an objective of the present invention to provide a ferrite circuit board, which has a wire firmly connected with a substrate and is capable of being used as an inductor.

To attain the above objective, the present invention provides a ferrite circuit board which comprises a substrate and a wire. The substrate is made of ferrite and has a surface and an elongated groove recessed from the surface. The elongated groove has an inner wall provided with an arithmetic mean roughness (hereinafter referred to as “roughness (Ra)”) of 0.1 μm to 20 μm and accommodates the wire.

Because the wire is completely embedded in the elongated groove of the substrate and the inner wall of the elongated groove has a predetermined roughness, the connection strength between the wire and the substrate can be improved in comparison with the prior art. In addition, because the elongated groove has a predetermined depth, the wire having a larger cross-sectional area can be embedded therein so as to allow a relatively large amount of current to flow therethrough. Furthermore, the elongated groove may be designed to have a spiral shape and accommodates the wire having the corresponding shape, so that the ferrite circuit board can also be used as an inductor to provide abundant functionality.

### BRIEF DESCRIPTION OF THE DRAWINGS

FIG. 1 is a top view of a ferrite circuit board according to a preferred embodiment of the present invention.

FIG. 2 is a cross-sectional view taken along line 2-2 of FIG. 1.

FIGS. 3 to 8 are photographs of real products of the ferrite circuit boards made according to examples 1 to 6 of the present invention.

### DETAILED DESCRIPTION OF EMBODIMENTS

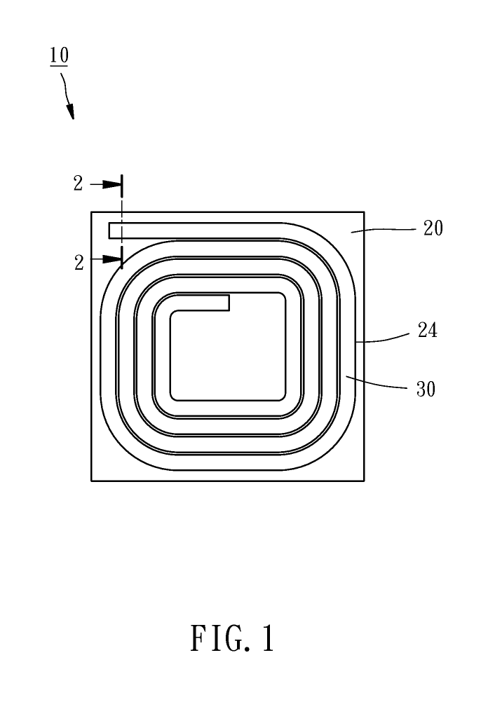

The structure and effect of the present invention will become more fully understood from the detailed description given herein below and the accompanying drawings. Referring to FIG. 1, a ferrite circuit board 10 according to a preferred embodiment of the present invention comprises a substrate 20 and a wire 30.

The substrate 20 is formed by sintering ferrite powder and the examples of ferrite powder may be Mn—Zn ferrite powder, Ni—Zn ferrite powder, Ni—Cu—Zn ferrite powder, Mn—Mg—Zn ferrite powder, Mn—Mg—Al ferrite powder, Mn—Cu—Zn ferrite powder, Co-ferrite powder, or the combination thereof. In another embodiment, the substrate 20 may be made of ferrite formed by another process.

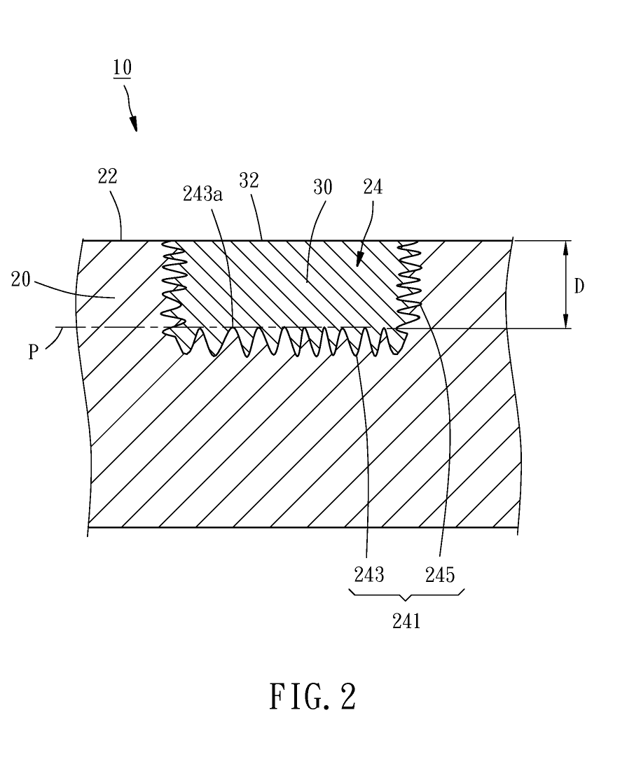

As shown in FIG. 2, the substrate 20 has a surface 22 and an elongated groove 24 recessed from the surface 22. The elongated groove 24 includes an inner wall 241 having a bottom surface 243 and two side surfaces 245. The bottom surface 243 and the side surfaces 245 of the inner wall 241 are irregular and the inner wall 241 has a roughness (Ra) of 0.1 μm to 20 μm. Specifically speaking, the bottom surface 243 has a plurality of crests 243a substantially located in an imaginary plane P that is approximately parallel to the surface 22. The distance D between the imaginary plane P and the surface 22 is defined as the depth D of the elongated groove 24, which ranges from 0.9 μm to 70 μm.

The wire 30 is made of metal with high electrical conductivity, such as copper (Cu), silver (Ag), gold (Au) and the like, and embedded in the elongated groove 24 of the substrate 20. The wire 30 has a top surface 32 substantially flush with the surface 22 of the substrate 20. In other words, the wire 30 has a shape complementary to that of the elongated groove 24 of the substrate 20. In this embodiment, as shown in FIG. 1, the elongated groove 24 is designed in a spiral shape and the wire 30 having a corresponding shape is embedded therein. In another embodiment, the shapes of the elongated groove 24 and the wire 30 may be varied according to an actual condition. In addition, the top surface 32 of the wire 30 may be lower or higher than the surface 22 of the substrate 20. Further, the numbers of the elongated groove 24 and the wire 30 are not specifically limited and may be varied according to the purpose of using the ferrite circuit board 10.

In the ferrite circuit board 10 of the present invention, because the wire 30 is completely accommodated in the elongated groove 24 of the substrate 20 and does not protrude out of the surface 22 of the substrate 20, and the bottom surface 243 and side surfaces 245 of the inner wall 241 are provided with a predetermined roughness (Ra) ranging from 0.1 μm to 20 μm, the wire 30 can be firmly fixed in the elongated groove 24. Therefore, the connection strength between the wire 30 and the substrate 20 is high enough such that the wire 30 is not easily separated from the substrate 20 even though it is very thin. In fact, the roughness (Ra) of bottom surface 243 and side surfaces 245 of the inner wall 241 of the elongated groove 24 is preferably in a range of 0.3 μm to 15 μm, and more preferably in a range of 0.5 μm to 10 μm. In addition, in this embodiment, because the elongated groove 24 of the substrate 20 is designed to have a spiral shape and accommodates the wire 30 having the corresponding shape and the ferrite substrate 20 has magnetism, the ferrite circuit board 10 of the present invention can also be used as an inductor, such that the ferrite circuit board 10 possesses abundant functionality. Moreover, because the elongated groove 24 has a depth D of 0.9 μm to 70 μm, the wire 30 may have a relatively greater thickness to allow a relatively large amount of current to flow therethrough. As such, the ferrite circuit board 10 of the present invention may be widely applied in many fields.

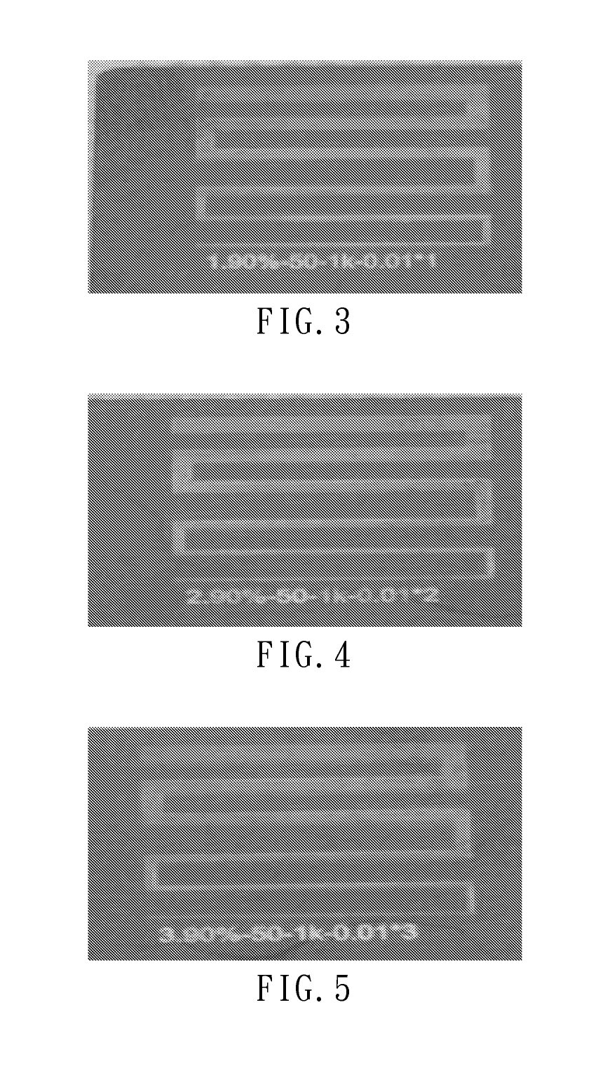

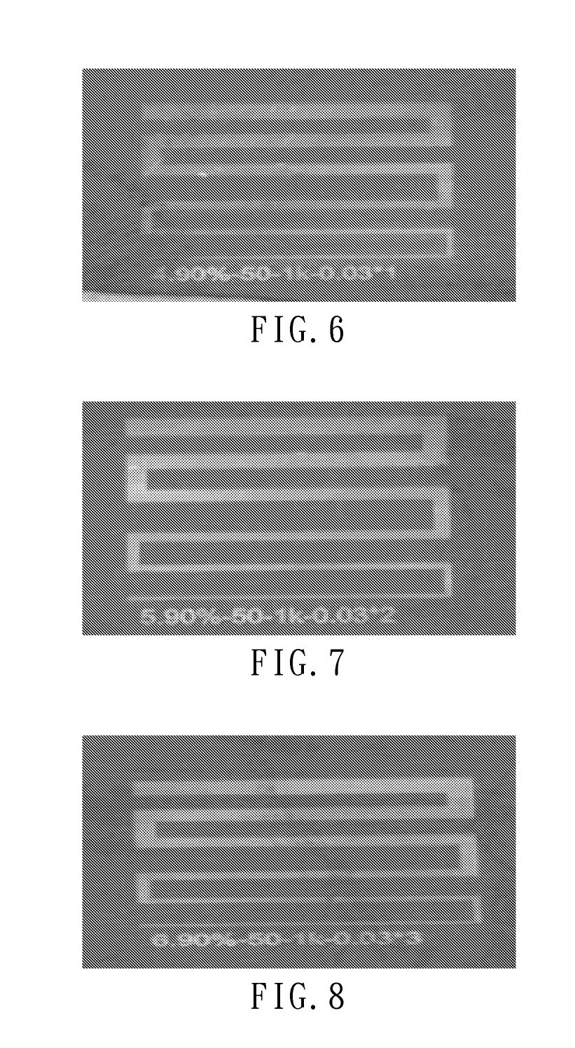

Referring to Table 1 below, it shows the ferrite circuit boards according to the examples 1 to 6 respectively, in which the depths D of the elongated grooves 24 of the examples are in the range of 0.9 μm to 20 μm and the roughnesses Ra of the inner walls 241 of the elongated grooves 24 of the examples are in the range of 0.3 μm to 10 μm. FIGS. 3 to 8 are photographs sequentially showing the real products of the ferrite circuit boards made according to the examples 1 to 6 listed in Table 1. As shown in the photographs, the elongated grooves 24 of the substrates 20 or the wires 30 located in the upper side are wider than those located far away from the upper side. In each of the examples, metal can be firmly embedded in the elongated groove 24 to form the complete wire 30. According to a further experimental result, in the case that the inner wall 241 of the elongated groove 24 has a roughness (Ra) ranging from 0.1 μm to 20 μm and a depth D ranging from 1 μm to 70 μm, the wire 30 can be firmly disposed in the elongated groove 24. On the contrary, when the depth D of the elongated groove 24 is less than 0.9 μm or the roughness (Ra) is less than 0.1 μm, a complete wire 30 cannot be easily firmly disposed in the elongated groove 24.

TABLE 1

| | parameter | |
|---|---|---|
| | depth | roughness |
| example | D (μm) | Ra (μm) |
| 1 | 0.9 | 0.3 |
| 2 | 1.7 | 1.2 |
| 3 | 5 | 3.7 |
| 4 | 10 | 5 |
| 5 | 15 | 5-10 |
| 6 | 20 | 5-10 |

It is worth mentioning that, the actual depth D of the elongated groove 24 is extremely thinner than the actual thickness of the substrate 20; however, in order to clearly express the technical feature of the present invention, the depth D is shown in exaggerated manner in FIG. 2. In another embodiments, the shape of the cross-section of the inner wall 241 of the elongated groove 24 may be semi-ellipse, semi-circle, irregularity, etc. It should be understood that the detailed description and specific example, while indicating preferred embodiment of the invention, are given by way of illustration only, and thus are not limitative of the present invention. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A ferrite circuit board comprising:
a substrate made of ferrite and having a surface and an elongated groove recessed from the surface, the elongated groove having an inner wall provided with a roughness (Ra) of 0.1 μm to 20 μm; and
a wire embedded in the elongated groove of the substrate.

2. The ferrite circuit board as claimed in claim 1, wherein the roughness (Ra) of the inner wall of the elongated groove of the substrate ranges from 0.3 μm to 15 μm.

3. The ferrite circuit board as claimed in claim 1, wherein the roughness (Ra) of the inner wall of the elongated groove of the substrate ranges from 0.5 μm to 10 μm.

4. The ferrite circuit board as claimed in claim 1, wherein the wire has a top surface substantially flush with the surface of the substrate.

5. The ferrite circuit board as claimed in claim 1, wherein the substrate is formed by sintering ferrite powder.

6. The ferrite circuit board as claimed in claim 1, wherein the elongated groove of the substrate has a depth ranging from 0.9 μm to 70 μm.

7. The ferrite circuit board as claimed in claim 1, wherein the elongated groove of the substrate has a spiral shape.
